(19) United States
(12) Patent Application Publication
(10) Pub. No.: US 2025/0087982 A1
(43) Pub. Date: Mar. 13, 2025

(54) VOLTAGE SOURCE TYPE DIRECT-CURRENT ICE MELTING APPARATUS, FLEXIBLE INTERCONNECTION SYSTEM AND CONTROL METHOD

(71) Applicant: ELECTRIC POWER RESEARCH INSTITUTE. CHINA SOUTHERN POWER GRID, Guangzhou, Guangdong (CN)

(72) Inventors: Yan XIONG, Guangzhou, Guangdong (CN); Yuebin ZHOU, Guangzhou, Guangdong (CN); Shukai XU, Guangzhou, Guangdong (CN); Wanyu CAO, Guangzhou, Guangdong (CN); Chuang FU, Guangzhou, Guangdong (CN)

(73) Assignee: ELECTRIC POWER RESEARCH INSTITUTE. CHINA SOUTHERN POWER GRID, Guangzhou, Guangdong (CN)

(21) Appl. No.: 18/563,930

(22) PCT Filed: Oct. 11, 2021
(86) PCT No.: PCT/CN2021/123053

§ 371 Date: Nov. 24, 2023

(30) Foreign Application Priority Data
May 25, 2021 (CN) 202110571864.9

(51) Int. Cl. H02G 7/16; H05B 1/02; H05B 3/00

(52) U.S. Cl. CPC H02G 7/16; H05B 1/023; H05B 3/0004

(57) ABSTRACT

A voltage source type direct-current ice melting apparatus, a flexible interconnection system and a control method are provided. The voltage source type direct-current ice melting apparatus includes a starting unit, a modular multi-level converter and a measurement control unit. The flexible interconnection system includes two voltage source type direct-current ice melting apparatuses having the same circuit structure. The measurement control unit acquires set values, that are input by a user, of relevant parameters and then processes the set values, that are input by the user, of the relevant parameters and measured values, measured in real time by the measurement control unit, of the relevant parameters, thereby determining and sending a control signal, so as to control an operating state of the modular multi-level converter in the apparatus or system.

### FIELD

The present application relates to the field of ice-melting technology for transmission lines, in particular to a voltage source type direct-current ice melting apparatus, a flexible interconnection system, and a control method thereof.

### BACKGROUND

Among the various natural disasters suffered by a power system, a freezing disaster is one of the most serious threats. Due to a freezing disaster, transmission lines may be covered with ice, seriously affecting the mechanical and electrical performance of the transmission lines, and even resulting in power supply interruption caused by tower collapse and disconnection. Transmission lines of a power grid pass through various regions with variable meteorological conditions, and are easily covered with ice in winter, resulting in a serious threat to stable and reliable operation of the power system.

With the development of economy and technology and the improvement of people's living conditions, electric energy has become an essential secondary energy source in people's production and life, providing conveniences for people's lives. Therefore, when the transmission lines of the power grid are covered with ice, power supply interruption may occur if the ice is not removed in time, seriously affecting people's daily lives.

### SUMMARY

According to the embodiments of the present disclosure, a voltage source type direct-current ice melting apparatus, a flexible interconnection system, and a control method thereof are provided.

A voltage source type direct-current ice melting apparatus includes: a starting unit, a modular multilevel converter, and a measurement control unit. A terminal of the starting unit is connected to an alternating-current power supply terminal, and another terminal of the starting unit is connected to an alternating-current input terminal of the modular multilevel converter. The starting unit is configured to connect the modular multilevel converter to an alternating-current power supply via the alternating-current power supply terminal. A direct-current output terminal of the modular multilevel converter is connected to a to-be-melted line in a case that the voltage source type direct-current ice melting apparatus operates in a direct-current ice melting mode. The measurement control unit is connected to the modular multilevel converter. The measurement control unit is configured to obtain a measurement value of an electrical parameter of the direct-current output terminal of the modular multilevel converter, determine a control signal based on the measurement value of the electrical parameter and a predetermined value of the electrical parameter, and control an operation state of the modular multilevel converter based on the control signal.

A flexible interconnection system includes: a first voltage source type direct-current ice melting apparatus and a second voltage source type direct-current ice melting apparatus. Each of the first voltage source type direct-current ice melting apparatus and the second voltage source type direct-current ice melting apparatus includes the voltage source type direct-current ice melting apparatus described above. The measurement control unit in the first voltage source type direct-current ice melting apparatus is connected to the measurement control unit in the second voltage source type direct-current ice melting apparatus. The direct-current output terminal of the modular multilevel converter in the first voltage source type direct-current ice melting apparatus is connected to the direct-current output terminal of the modular multilevel converter in the second voltage source type direct-current ice melting apparatus, so that the first voltage source type direct-current ice melting apparatus and the second voltage source type direct-current ice melting apparatus are connected in parallel.

A control method for a voltage source type direct-current ice melting apparatus is provided. The control method is performed by the voltage source type direct-current ice melting apparatus described above. In a case that the voltage source type direct-current ice melting apparatus operates in a direct-current ice melting mode, the control method includes: controlling, by the starting unit, an alternating current to flow to the modular multilevel converter; converting, by the modular multilevel converter 20, the alternating current to a direct current, and outputting the direct current via the direct-current output terminal of the modular multilevel converter; and obtaining, by the measurement control unit, a measurement value and a predetermined value of the direct current outputted via the direct-current output terminal, and controlling the operation state of the modular multilevel converter based on the measurement value and the predetermined value of the direct current to control a current value of a direct current outputted from the direct-current output terminal to the to-be-melted line.

A control method for a flexible interconnection system is provided. The control method is performed by the flexible interconnection system described above. In a case that the flexible interconnection system operates in a flexible interconnection mode, the direct-current output terminal of the modular multilevel converter in the first voltage source type direct-current ice melting apparatus and the direct-current output terminal of the modular multilevel converter in the second voltage source type direct-current ice melting apparatus are not connected to the to-be-melted line, and the control method includes: controlling, by the starting unit in the first voltage source type direct-current ice melting apparatus, an alternating current to flow to the modular multilevel converter in the first voltage source type direct-current ice melting apparatus, and controlling, by the starting unit in the second voltage source type direct-current ice melting apparatus, an alternating current to flow to the modular multilevel converter in the second voltage source type direct-current ice melting apparatus; converting, by the modular multilevel inverter in the first voltage source type direct-current ice melting apparatus, the alternating current to a direct current, and outputting, by the modular multilevel inverter in the first voltage source type direct-current ice melting apparatus, the direct current; and converting, by the modular multilevel inverter in the second voltage source type direct-current ice melting apparatus, the alternating current to a direct current, and outputting, by the modular multilevel inverter in the second voltage source type direct-current ice melting apparatus, the direct current; and controlling, by the measurement control unit in the first voltage source type direct-current ice melting apparatus, the operation state of the modular multilevel converter in the first voltage source type direct-current ice melting apparatus, and controlling, by the measurement control unit in the second voltage source type direct-current ice melting apparatus, the operation state of the modular multilevel converter in the second voltage source type direct-current ice melting apparatus. An active power is transferred between the alternating-current power supply terminal connected to the first voltage source type direct-current ice melting apparatus and the alternating-current power supply terminal connected to the second voltage source type direct-current ice melting apparatus.

Details of one or more embodiments of the present disclosure are provided in the accompanying drawings and descriptions below. Other features, objectives, and advantages of present disclosure become apparent from the specification, the drawings, and the claims

### BRIEF DESCRIPTION OF THE DRAWINGS

In order to clearly illustrate technical solutions in the embodiments of the present disclosure or in the conventional technology, the drawings used in the description of the embodiments or the conventional technology are briefly described below. It is apparent that the drawings in the following description show only some embodiments of the present disclosure, and other drawings may be obtained by those skilled in the art based on the drawings without any creative efforts.

FIG. 1 is a schematic structural diagram of a voltage source type direct-current ice melting apparatus according to an embodiment of the present disclosure;

FIG. 2 is a circuit diagram of a voltage source type direct-current ice melting apparatus operating in a direct-current ice melting mode according to an embodiment of the present disclosure;

FIG. 3 is a flowchart of a control method for a voltage source type direct-current ice melting apparatus operating in a direct-current ice melting mode according to an embodiment of the present disclosure;

FIG. 4 is a circuit diagram of a voltage source type direct-current ice melting apparatus operating in a reactive power compensation mode according to an embodiment of the present disclosure;

FIG. 5 is a flowchart of a control method for a voltage source type direct-current ice melting apparatus operating in a reactive power compensation mode according to an embodiment of the present disclosure;

FIG. 6 is a schematic structural diagram of a flexible interconnection system according to an embodiment of the present disclosure;

FIG. 7 is a circuit diagram of a flexible interconnection system operating in a flexible interconnection mode according to an embodiment of the present disclosure;

FIG. 8 is a flowchart of a control method for a flexible interconnection system operating in a flexible interconnection mode according to an embodiment of the present disclosure; and

FIG. 9 is a circuit diagram of a flexible interconnection system operating in a direct-current ice melting mode according to an embodiment of the present disclosure.

### DETAILED DESCRIPTION OF THE EMBODIMENTS

The technical solutions in embodiments in the present disclosure are described clearly and completely hereinafter with reference to the drawings in the embodiments of the present disclosure. It is apparent that the embodiments described are only some rather than all the embodiments of the present disclosure. Any other embodiments acquired by those skilled in the art based on the embodiments in the present disclosure without any creative efforts fall within the protection scope of the present disclosure.

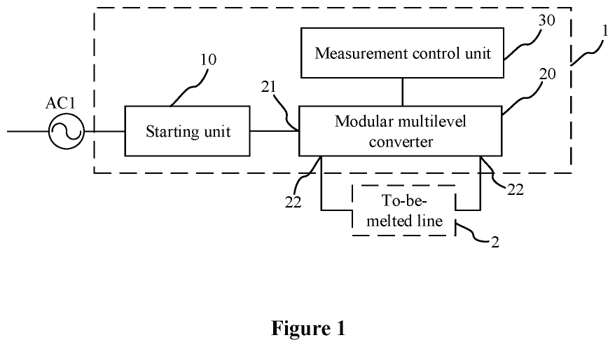

FIG. 1 is a schematic structural diagram of a voltage source type direct-current ice melting apparatus 1 according to an embodiment of the present disclosure. The voltage source type direct-current ice melting apparatus 1 may include: a starting unit 10, a modular multilevel converter (MMC) 20, and a measurement control unit 30.

In an embodiment, the modular multilevel converter 20 is arranged with an alternating-current input terminal 21 and a direct-current output terminal 22. The modular multilevel converter 20 is configured to convert an alternating current flowing in via the alternating-current input terminal 21 to a direct current and output the direct current via the direct-current output terminal 22.

A terminal of the starting unit 10 is connected to an alternating-current power supply AC1, and another terminal of the starting unit 10 is connected to the alternating-current input terminal 21 of the modular multilevel converter 20 to control an alternating current to flow to the modular multilevel converter 20.

The direct-current output terminal 22 of the modular multilevel converter 20 is connected to a to-be-melted line 2 in a case that the voltage source type direct-current ice melting apparatus 1 operates in a direct-current ice melting mode. In the case that the voltage source type direct-current ice melting apparatus 1 operates in the direct-current ice melting mode, the direct-current output terminal 22 of the modular multilevel converter 20 may output a direct-current ice melting current of hundreds or thousands of amperes. When the direct-current ice melting current flows through the to-be-melted line 2, the to-be-melted line 2 generates heat to melt the ice covered on the to-be-melted line 2.

The measurement control unit 30 is connected to the modular multilevel converter 20. The measurement control unit 30 is configured to obtain a measurement value of an electrical parameter of the direct-current output terminal 22 of the modular multilevel converter 20, determine a control signal based on the measurement value of the electrical parameter and a predetermined value of the electrical parameter, and output the control signal to the modular multilevel converter 20 to control an operation state of the modular multilevel converter 20. The electrical parameter may be a direct current parameter, a direct-current voltage parameter, or the alike.

In the embodiment, the voltage source type direct-current ice melting apparatus 1, operating in the direct-current ice melting mode, may perform direct-current ice melting. In the case that the voltage source type direct-current ice melting apparatus 1 enters into the direct-current ice melting mode, the starting unit 10 controls the alternating current to flow to the modular multilevel converter 20, and the measurement control unit 30 controls the operation state of the modular multilevel converter 20. The modular multilevel converter 20 converts the alternating current to a direct current, and outputs the direct current via the direct-current output terminal 22 of the modular multilevel converter 20. The measurement control unit 30 obtains the measurement value and the predetermined value of the direct current outputted via the direct-current output terminal 22 of the modular multilevel converter 20, and determines a control signal based on the measurement value and the predetermined value of the direct current to control the operation state of the modular multilevel converter 20. The direct current outputted from the direct-current output terminal 22 of the modular multilevel converter 20 may be adjusted to hundreds or thousands of amperes. After the direct current flow through the to-be-melted line 2, the to-be-melted line 2 generates heat, and then the ice covered on the to-be-melted line 2 is melted.

In an embodiment, the voltage source type direct-current ice melting apparatus 1 may be configured to perform reactive power compensation on the alternating-current power supply AC1 in a reactive power compensation mode. When the voltage source type direct-current ice melting apparatus 1 enters into the reactive power compensation mode, the direct-current output terminal 22 of the modular multilevel converter 20 is disconnected from the to-be-melted line 2. The starting unit 10 controls an alternating current to flow to the modular multilevel converter 20, and the measurement control unit 30 controls the operation state of the modular multilevel converter 20, so that the modular multilevel converter 20 absorbs a reactive power from the alternating-current power supply AC1 or outputs a reactive power to the alternating-current power supply AC1. In a case that the measurement control unit 30 measures that the alternating-current power supply AC1 has an excessive reactive power (such as greater than a first predetermined value), the measurement control unit 30 controls the modular multilevel converter 20 to absorb a reactive power from the alternating-current power supply AC1; and in a case that the measurement control unit 30 measures that the alternating-current power supply AC1 has an insufficient reactive power (such as less than a second predetermined value), the measurement control unit 30 controls the modular multilevel converter 20 to output a reactive power to the alternating-current power supply AC1, thereby performing reactive power compensation on the alternating-current power supply AC1.

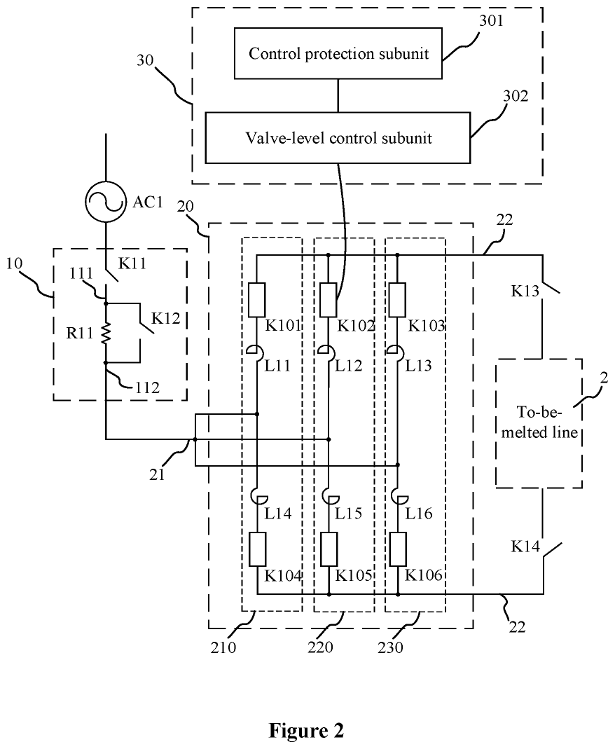

In some embodiments of the present disclosure, as shown in FIG. 2, the starting unit 10 in the voltage source type direct-current ice melting apparatus 1 may include: an alternating-current breaker K11, a charging resistor R11, and a bypass switch K12.

The bypass switch K12 and the charging resistor R11 are connected in parallel. A first common terminal 111 of the bypass switch K12 and the charging resistor R11 connected in parallel is connected to the alternating-current power supply AC1 through the alternating-current breaker K11. A second common terminal 112 of the bypass switch K12 and the charging resistor R11 connected in parallel is connected to a connection point of a upper bridge arm and a lower bridge arm in each of phases in the modular multilevel converter 20.

The alternating-current circuit breaker K11 is configured to control the alternating current to flow to the voltage source type direct-current ice melting apparatus 1.

The charging resistor R11 is configured to limit a current in starting up the voltage source type direct-current ice melting apparatus 1, avoiding damaging the modular multilevel converter 20 by a large current generated at a time instant when the voltage source type direct-current ice melting apparatus 1 is powered on. In selecting the charging resistor R11, it is required to consider factors such as a maximum allowable current of the voltage source type direct-current ice melting apparatus 1, a starting speed, and a resistor volume.

The bypass switch K12 is configured to disconnect the charging resistor R11 to remove the limitation on the alternating current flowing to the voltage source type direct-current ice melting apparatus 1. It should be understood that the charging resistor R11 consumes a large power due to a large current flowing through a charging circuit of the voltage source type direct-current ice melting apparatus 1. In a case that the charging resistor R11 is connected in series in the charging circuit for a long time, the charging resistor R11 is to be damaged due to overheating. Therefore, after the voltage source type direct-current ice melting apparatus 1 is powered on, when internal capacitor voltages of flexible direct-current converter valves (K101, K102, K103, K104, K105, and K106) in the voltage source type direct-current ice melting apparatus 1 reach a predetermined threshold, it is required to close the bypass switch K12, so that the alternating current flows through the bypass switch K12 instead of through the charging resistor R11, thereby disconnecting the charging resistor R11 to protect the charging resistor R11.

In an embodiment, as shown in FIG. 2, the modular multilevel converter 20 in the voltage source type direct-current ice melting apparatus 1 may include: a first phase 210, a second phase 220 and a third phase 230 which have a same structure. Each of the first phase 210, the second phase 220, and the third phase 230 includes an upper bridge arm and a lower bridge arm. Each of upper bridge arms includes a flexible direct-current converter valve (K101/K102/K103) and a bridge arm reactor (L11/L12/L13) connected in series. Each of lower bridge arms includes a bridge arm reactor (L14/L15/L16) and a flexible direct-current converter valve (K104/K105/K106) connected in series. In each of the first phase, the second phase and the third phase, the bridge arm reactor (L11/L12/L13) in the upper bridge arm and the bridge arm reactor (L14/L15/L16) in the lower bridge arm are connected in series in a same direction.

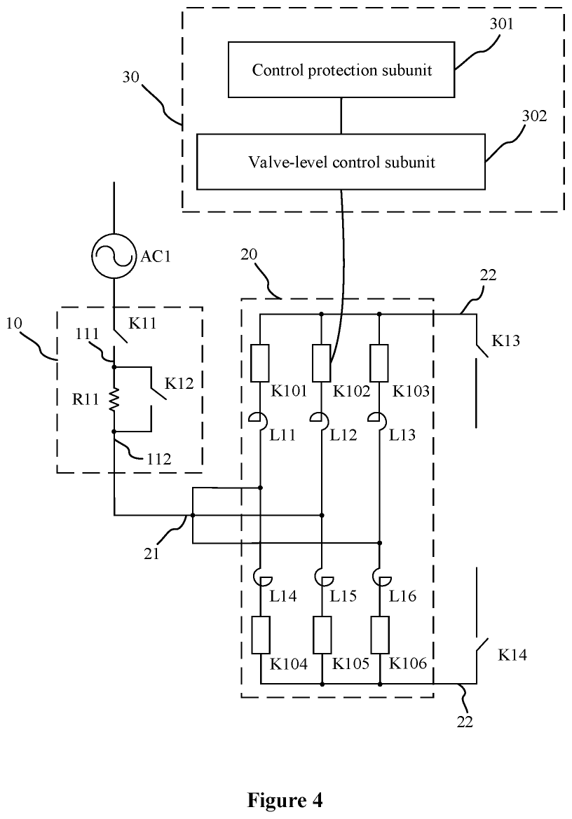

All the flexible direct-current converter valves (K101, K102, K103, K104, K105 and K106) in the upper bridge arms and the lower bridge arms in the modular multilevel converter 20 are connected to a valve-level control subunit 302 in the measurement control unit 30. It should be noted that for the sake of simplicity in the figures, FIGS. 2 and 4 only show the connection between the valve-level control subunit 302 and the flexible direct-current converter valve K102, and do not show connections between the other flexible direct-current converter valves (K101, K103, K104, K105 and K106) and the valve-level control subunit 302.

The bridge arm reactors (L11, L12, L13, L14, L15 and L16) are configured to suppress the modular multilevel converter 20 outputting a current harmonic and rapid rise of current in each of the upper bridge arms and the lower bridge arms in a case of circulation and short circuits between the upper bridge arms and the lower bridge arms.

The flexible direct-current converter valves (K101, K102, K103, K104, K105 and K106) are configured to perform conversion between alternating current and direct current, and output and absorb a reactive power. Each of the flexible direct-current converter valves includes multiple power modules connected in series. The power modules are full bridge modules or half bridge modules based on insulated gate bipolar transistors (IGBTs).

Each of the insulated gate bipolar transistors is a composite fully controlled voltage driven power semiconductor device including a bipolar junction transistor (BJT) and an insulated gate field-effect transistor (MOS), and has a low driving power and a reduced saturation voltage.

In an embodiment, as shown in FIG. 2, the measurement control unit 30 in the voltage source type direct-current ice melting apparatus 1 may include: a control protection subunit 301, a valve-level control subunit 302, and a measurement subunit (not shown in FIG. 2).

The control protection subunit 301 is connected to the measurement subunit and the valve-level control subunit 302. The control protection subunit 301 is configured to receive the measurement value of the electrical parameter of the modular multilevel converter 20 from the measurement subunit in real time, and transmit the control signal to the valve-level control subunit 302 to control the operation state of the flexible direct-current converter valves (K101, K102, K103, K104, K105 and K106).

The control protection subunit 301 is configured to obtain the predetermined value inputted by the user, obtain a modulation signal based on the predetermined value and the obtained measurement value of the electrical parameter from the measurement subunits in the voltage source type direct-current ice melting apparatus 1 in real time, transmit the modulation signal to the valve-level control subunit 302, and transmit a switch signal to the starting unit 10 to adjust the alternating current flowing to the voltage source type direct-current ice melting apparatus 1. In addition, the control protection subunit 301 is further configured to monitor various electrical parameters of the voltage source type direct-current ice melting apparatus 1 in operation. When it is monitored that the electrical parameters are abnormal, the control protection subunit 301 controls corresponding devices to adjust the electrical parameters or cuts off the power supply of the voltage source type direct-current ice melting apparatus 1 to protect the voltage source type direct-current ice melting apparatus 1.

The valve-level control subunit 302 is configured to detect a capacitor voltage of each of the flexible direct-current converter valves (K101, K102, K103, K104, K105 and K106) in the modular multilevel converter 20 after the alternating current is inputted to the modular multilevel converter 20. On detecting that the capacitor voltage reaches a predetermined unlocking threshold, the valve-level control subunit 302 transmits a signal to the flexible direct-current converter valves (K101, K102, K103, K104, K105 and K106) in the modular multilevel converter 20 to unlock the flexible direct-current converter valves (K101, K102, K103, K104, K105 and K106). In addition, after the flexible direct-current converter valves (K101, K102, K103, K104, K105 and K106) are unlocked, the valve-level control subunit 302 receives a modulation signal from the control protection subunit 301, determines a control signal based on the modulation signal, and transmits the control signal to the flexible direct-current converter valves (K101, K102, K103, K104, K105 and K106) in the modular multilevel converter 20 to control the operation states of the flexible direct-current converter valves (K101, K102, K103, K104, K105 and K106), thereby adjusting the direct current and the direct-current voltage outputted by the flexible direct-current converter valves (K101, K102, K103, K104, K105 and K106), and outputting or absorbing a reactive power.

The measurement subunit is configured to measure an electrical parameter of the direct-current output terminal of the modular multilevel converter 20 and an electrical parameter of an output terminal of the alternating-current power supply AC1 (hereinafter referred to as an “alternating-current power supply terminal”). It should be understood that the voltage source type direct-current ice melting apparatus 1 may include multiple measurement subunits, and a measurement subunit is arranged at the direct-current output terminal of the modular multilevel converter 20 and a measurement subunit is arranged at the alternating-current power supply terminal. The measurement subunits may measure electrical parameters required by the voltage source type direct-current ice melting apparatus 1, and transmit measurement values of the electrical parameters to the control protection subunit 301 in real time. It should be noted that for the sake of simplicity in the figures, positions at which the measurement subunits are arranged and connections between the measurement subunits and the control protection subunit 301 are not shown in the figures. The specific positions are determined based on that accurate measurement of required electrical parameters can be performed.

In some embodiments of the present disclosure, as shown in FIG. 2, the voltage source type direct-current ice melting apparatus 1 may further include a first switch (switch K13) and a second switch (switch K14). The switches K13 and K14 are connected to the direct-current output terminal 22 of the modular multilevel converter 20 to control the opening or closing of the direct-current output terminal 22. In a case that the voltage source type direct-current ice melting apparatus 1 operates in the direct-current ice melting mode, the direct-current output terminal 22 of the modular multilevel converter 20 may be connected to the to-be-melted line through the switches K13 and K14.

In some embodiments of the present disclosure, the measurement control unit 30 may further be connected to the starting unit 10, and may be configured to control the starting unit 10 to adjust the alternating current flowing to the voltage source type direct-current ice melting apparatus 1. As shown in FIG. 2, the measurement control unit 30 is connected to the starting unit 10. Specifically, the control protection subunit 301 is connected to the bypass switch K12. When the internal capacitor voltages of the flexible direct-current converter valves (K101, K102, K103, K104, K105 and K106) reach the predetermined threshold, the control protection subunit 301 transmits a switch signal to the bypass switch K12, then the bypass switch K12 is turned on in response to the switch signal, so that the alternating current does not flow to the charging resistor R11, removing the limitation on the alternating current flowing to the voltage source type direct-current ice melting apparatus 1. It should be noted that for the sake of simplicity in the figures, the connection between the control protection subunit 301 and the bypass switch K12 is not shown in the FIG. 2.

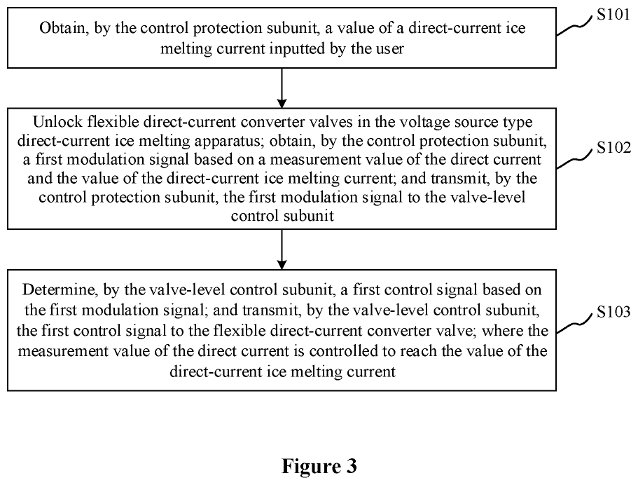

Based on the voltage source type direct-current ice melting apparatus 1 according to the above embodiments, a control method is provided in the present disclosure. In a case that the voltage source type direct-current ice melting apparatus 1 operates in the direct-current ice melting mode, based on the circuit diagram shown in FIG. 2, FIG. 3 shows a flowchart of a control method for a voltage source type direct-current ice melting apparatus operating in a direct-current ice melting mode according to an embodiment of the present disclosure. Referring to FIG. 3, the control method may include the following steps S101 to S103.

In step S101, the control protection subunit obtains a value of a direct-current ice melting current inputted by the user.

Specifically, the control protection subunit 301 in the measurement control unit 30 may obtain the value of the direct-current ice melting current inputted by the user through a control interface. The value of the direct-current ice melting current may be determined by the user based on an analysis of a current line icing situation. The analysis may be performed based on experiences, or may be calculated based on weather conditions of the day or recent days and the thickness of the ice covering on the line. It should be understood that the value of the direct-current ice melting current should be configured within a range that the voltage source type direct-current ice melting apparatus 1 can withstand. Moreover, based on the predetermined value of the direct-current ice melting current, it should be ensured that sufficient heat is generated to melt the snow and ice covering on the lines of the power grid.

In step S102, the flexible direct-current converter valves in the voltage source type direct-current ice melting apparatus are unlocked, the control protection subunit obtains a first modulation signal based on a measurement value of the direct current and the value of the direct-current ice melting current, and the control protection subunit transmits the first modulation signal to the valve-level control subunit.

Specifically, after the alternating-current breaker K11 in the starting unit 10 of the voltage source type direct-current ice melting apparatus 1 is closed, the alternating current flows to the upper bridge arms and the lower bridge arms of the phases in the modular multilevel converter 20 through the alternating-current breaker K11 and the charging resistor R11. The valve-level control subunit 302 in the measurement control unit 30 begins to obtain the capacitor voltage of the flexible direct-current converter valves (K101, K102, K103, K104, K105 and K106) in the modular multilevel converter 20. On detecting that the capacitor voltage of the flexible direct-current converter valves (K101, K102, K103, K104, K105 and K106) is increased to around 1.0 pu, the valve level control subunit 302 determines that an unlocking condition is met and transmits a first signal to the flexible direct-current converter valves (K101, K102, K103, K104, K105 and K106). The flexible direct-current converter valves (K101, K102, K103, K104, K105 and K106) are unlocked based on the first signal, and switch from a closed state to a conduction state to perform normal operations. The unlocking steps of the flexible direct-current converter valves are described above.

After the flexible direct-current converter valves (K101, K102, K103, K104, K105 and K106) are unlocked, the direct-current output terminal of the modular multilevel converter 20 begins to output a direct current. The control protection subunit 301 obtains a measurement value of the direct current from the direct-current measurement subunit arranged at the direct-current output terminal of the modular multilevel converter 20 in real time by, obtains a first modulation signal based on the measurement value of the direct current obtained in real time and the value of the direct-current ice melting current inputted by the user, and transmits the first modulation signal to the valve-level control subunit 302.

In an embodiment, in order to prevent damage to the charging resistor R11 due to overheat caused by excessive power consumption of the charging resistor R11 connected in series in the charging circuit for a long time, before the flexible direct-current converter valves (K101, K102, K103, K104, K105 and K106) are unlocked, the valve-level control subunit 302 determines that the charging is completed when the capacitor voltage of the flexible direct-current converter valves (K101, K102, K103, K104, K105 and K106) reaches 0.3 pu to 0.5 pu, and the valve-level control subunit 302 transmits a feedback signal to the control protection subunit 301. Thus, the control protection subunit 301 transmits a switch signal to the bypass switch K12 based on the feedback signal from the valve-level control subunit 302. The bypass switch K12 is controlled to be closed, so that the charging resistor R11 is disconnected, avoiding damage to the charging resistor caused by connected in series in the charging circuit for a long time. After the charging resistor R11 is disconnected, the capacitor voltage of the flexible direct-current converter valves (K101, K102, K103, K104, K105 and K106) is continuously increased.

The charging resistor R11 may be disconnected by performing the following operations. The control protection subunit 301 transmits a signal through the connection between the control protection subunit 301 and the bypass switch K12 to control the bypass switch K12 to be closed. Alternatively, after the control protection subunit 301 receives the feedback signal from the valve-level control subunit 302, the user is remaindered in a visible manner to close the bypass switch K12, thereby disconnecting the charging resistor R11.

In step S103, the valve-level control subunit determines a first control signal based on the first modulation signal, and transmits the first control signal to the flexible direct-current converter valve, so that the measurement value of the direct current reaches the value of the direct-current ice melting current.

Specifically, the valve-level control subunit 302 determines a first control signal based on the first modulation signal, and transmits the first control signal to the flexible direct-current converter valves (K101, K102, K103, K104, K105 and K106) in the modular multilevel converter 20 for controlling the operation states of the flexible direct-current converter valves (K101, K102, K103, K104, K105 and K106) in the modular multilevel converter 20, so that the measurement value of the direct current at the direct-current output terminal 22 of the modular multilevel converter 20 reaches the value of the direct-current ice melting current inputted by the user. Since the direct-current output terminal 22 of the modular multilevel converter 20 is connected to the to-be-melted line 2, the direct current flows through the to-be-melted line 2, so that the to-be-melted line 2 generates a large amount of heat, melting the ice attached to the surface of the to-be-melted line 2.

The voltage source type direct-current ice melting apparatus 1 in the above embodiments may perform direct-current ice melting, and may perform reactive power compensation for the alternating-current power supply. Based on the voltage source type direct-current ice melting apparatus 1 according to the above embodiments, a control method is provided according to another embodiment of the present disclosure.

In a case that the voltage source type direct-current ice melting apparatus 1 operates in a reactive power compensation mode, as shown in FIG. 4, the direct-current output terminal 22 of the modular multilevel converter 20 is disconnected, that is, the direct-current output terminal 22 is disconnected from the to-be-melted line 2. In an embodiment, in a case that the direct-current output terminal 22 of the modular multilevel converter 20 is connected to the to-be-melted line 2 through the switches K13 and K14, the direct-current output terminal 22 and the to-be-melted line 2 may be controlled to be connected or disconnected by turning on or turning off at least one of the switches K13 and K14 in the reactive power compensation mode.

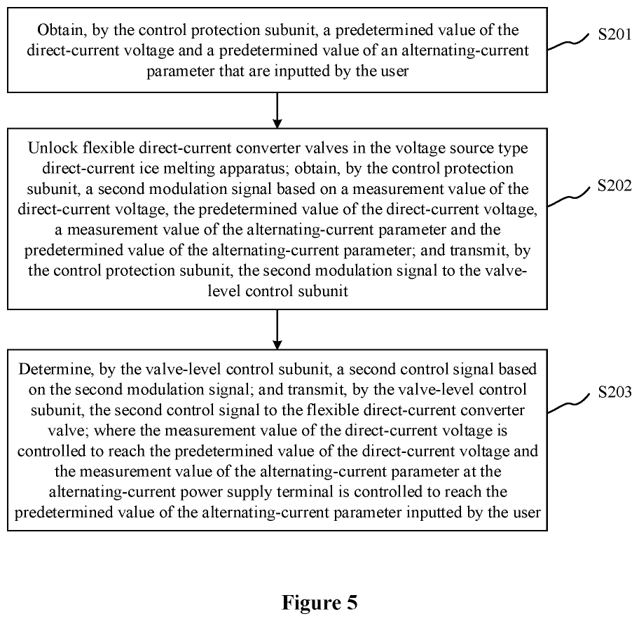

FIG. 5 shows a flowchart of a control method for a voltage source type direct-current ice melting apparatus 1 operating in a reactive power compensation mode according to an embodiment of the present disclosure. Referring to FIG. 5, the control method may include steps S201 to S203.

In step S201, the control protection subunit obtains a predetermined value of a direct-current voltage and a predetermined value of an alternating-current parameter inputted by the user.

Specifically, the control protection subunit 301 in the measurement control unit 30 may obtain the predetermined value of the direct-current voltage and the predetermined value of the alternating-current parameter inputted by the user through a control interface. The direct-current voltage is a direct-current voltage of the direct-current output terminal 22 of the modular multilevel converter 20. The alternating-current parameter is an alternating-current parameter of the alternating-current power supply terminal that is affected by the flexible direct-current converter valves (K101, K102, K103, K104, K105 and K106) absorbing a reactive power or outputting a reactive power, and the alternating-current parameter includes factors such as a reactive power, an alternating-current voltage amplitude or an alternating-current power factor of the alternating-current power supply terminal.

It should be understood that the alternating-current parameter, affected by the flexible direct-current converter valves (K101, K102, K103, K104, K105 and K106) absorbing a reactive power or outputting a reactive power, has a direct relationship with a current requirement for the reactive power of the power grid. The reactive power is required in the power grid. In normal situations, it is required for the electrical devices to obtain reactive powers from the power supply. In a case that the reactive power in the power grid is insufficient, the electrical device does not have enough reactive power to establish a normal electromagnetic field, thus the electrical device cannot operate in a rated condition, resulting in a decrease in a terminal voltage of the electrical device and affecting the normal operation of the electrical device. In a case there is too much reactive power in the power grid, an output of an active power of a generator is reduced, resulting in increasing the voltage loss of lines and the electrical energy loss. Therefore, the inputted predetermined value of the reactive power is determined by the user based on the requirement for the reactive power of the power grid. Furthermore, the alternating-current voltage amplitude and the alternating-current power at the alternating-current power supply terminal are affected by the reactive power under normal situations. Therefore, it may be determined whether the requirement for the reactive power of the power grid is in a balanced state by configuring the alternating-current voltage amplitude and the alternating-current power.

In step S202, the flexible direct-current converter valves in the voltage source type direct-current ice melting apparatus are unlocked, the control protection subunit obtains a second modulation signal based on the measurement value of the direct-current voltage, the predetermined value of the direct-current voltage, the measurement value of the alternating-current parameter and the predetermined value of the alternating-current parameter, and the control protection subunit transmits the second modulation signal to the valve-level control subunit.

Specifically, the step of unlocking the flexible direct-current converter valves (K101, K102, K103, K104, K105 and K106) is similar to the step of unlocking the flexible direct-current converter valves in step S102 of the control method for the voltage source type direct-current ice melting apparatus 1 operating in the direct-current ice melting mode shown in FIG. 3.

The control protection subunit 301 obtains measurement values by using the direct-current voltage measurement subunit and the alternating-current parameter measurement subunits arranged in the voltage source type direct-current ice melting apparatus 1. The control protection subunit 301 obtains the second modulation signal based on the measurement value of the direct-current voltage, the predetermined value of the direct-current voltage inputted by the user, the measurement value of the alternating-current parameter, and the predetermined value of the alternating-current parameter inputted by the user, and transmits the second modulation signal to the valve-level control subunit 302.

It should be understood that the direct-current voltage measurement subunit is arranged at the direct-current output terminal 22 of the modular multilevel converter 20. The alternating-current parameter measurement subunits are arranged at different positions of the alternating-current power supply terminal based on the different alternating-current parameters. It should be noted that for the simplicity of the figures, the measurement subunits are not shown in the figures. The specific positions are determined based on that accurate measurement of required electrical parameters can be performed.

In step S203, the valve-level control subunit determines a second control signal based on the second modulation signal and transmits the second control signal to the flexible direct-current converter valve, so that the measurement value of the direct-current voltage reaches the predetermined value of the direct-current voltage and the measurement value of the alternating-current parameter of the alternating-current power supply terminal reaches the predetermined value of the alternating-current parameter inputted by the user.

Specifically, the valve-level control subunit 302 determines a second control signal based on the second modulation signal, and transmits the second control signal to the flexible direct-current converter valves (K101, K102, K103, K104, K105 and K106) in the modular multilevel converter 20 to control the operation states of the flexible direct-current converter valves (K101, K102, K103, K104, K105 and K106) in the modular multilevel converter 20, so that the flexible direct-current converter valves (K101, K102, K103, K104, K105 and K106) absorb a reactive power or output a reactive power, the measurement value of the direct-current voltage outputted from the direct-current output terminal 22 of the modular multilevel converter 20 reaches the predetermined value of the direct-current voltage, and the measurement value of the alternating-current parameter at the alternating-current power supply terminal reaches the predetermined value of the alternating-current parameter inputted by the user.

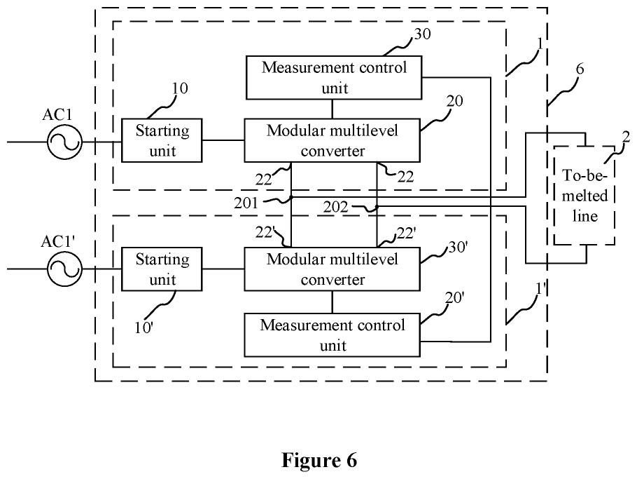

A flexible interconnection system 6 is further provided according to an embodiment of the present disclosure. Reference is made to FIG. 6, which shows a schematic structural diagram of a flexible interconnection system 6 according to an embodiment of the present disclosure.

As shown in FIG. 6, the flexible interconnection system includes a voltage source type direct-current ice melting apparatus 1 and a voltage source type direct-current ice melting apparatus 1′ as shown in FIG. 1. A measurement control unit 30 in the voltage source type direct-current ice melting apparatus 1 is connected to a measurement control unit 30′ in the voltage source type direct-current ice melting apparatus 1′. A direct-current output terminal 22 of a modular multilevel inverter 20 in the voltage source type direct-current ice melting apparatus 1 is connected to a direct current output terminal 22′ of a modular multilevel inverter 20′ in the voltage source type direct-current ice melting apparatus 1′, thus the voltage source type direct-current ice melting apparatus 1 and the voltage source type direct-current ice melting apparatus 1′ are connected in parallel at the direct-current side.

The flexible interconnection system 6 may perform flexible interconnection between two alternating-current power supplies AC1 and AC1′. When the flexible interconnection system 6 enters into a flexible interconnection mode, a starting unit 10 controls an alternating current to flow to a modular multilevel converter 20 and a starting unit 10′ controls an alternating current to flow to a modular multilevel converter 20′, and a measurement control unit 30 controls an operation state of the modular multilevel converter 20 and a measurement control unit 30′ controls the operation state of the modular multilevel converter 20′, so that each of the modular multilevel converters 20 and the modular multilevel converters 20′ performs conversion between an alternating current and a direct current. By controlling the operation state of the modular multilevel converter 20 (20′) with the measurement control unit 30 (30′), flexible interconnection may be performed between the alternating-current power supply AC1 in the voltage source type direct-current ice melting apparatus 1 and the alternating-current power supply AC1′ in the voltage source type direct-current ice melting apparatus 1′ in the flexible interconnection system 6. It should be understood that in the flexible interconnection mode, the alternating-current power supply AC1 and the alternating-current power supply AC1′, that are originally not connected, are connected to each other through the flexible interconnection system 6, and the alternating-current power supply AC1 and the alternating-current power supply AC1′ may transfer energy between each other through the flexible interconnection system 6.

It is assumed that a terminal A of the flexible interconnection system 6 is connected to the alternating-current power supply AC1, a terminal B of the flexible interconnection system 6 is connected to the alternating-current power supply AC1′, and the modular multilevel converter 20 at the terminal A absorbs or outputs an active power. In a case that the alternating-current power supply AC1 at the terminal A has insufficient active power (less than a third predetermined value) and the alternating-current power supply AC1′ at the terminal B has sufficient active power (greater than a fourth predetermined value), the modular multilevel converter 20 at the terminal A absorbs active power from the alternating-current power supply AC1′ at the terminal B. In a case that the alternating-current power supply AC1 at the terminal A has sufficient active power (greater than the fourth predetermined value) and the alternating-current power supply AC1′ at the terminal B has insufficient active power (less than the third predetermined value), the modular multilevel converter 20 at the terminal A outputs active power to the alternating-current power supply AC1′ at the terminal B. Thus, flexible interconnection is performed between the alternating-current power supply AC1 and the alternating-current power supply AC1′.

In an embodiment, when the flexible interconnection system 6 enters into the flexible interconnection mode, the voltage source type direct-current ice melting apparatus 1 in the flexible interconnection system 6 may control the operation state of the modular multilevel converter 20 in the voltage source type direct-current ice melting apparatus 1 through the measurement control unit 30 in the voltage source type direct-current ice melting apparatus 1, and the voltage source type direct-current ice melting apparatus 1′ in the flexible interconnection system 6 may control the operation state of the modular multilevel converter 20′ in the voltage source type direct-current ice melting apparatus 1′ through the measurement control unit 30′ in the voltage source type direct-current ice melting apparatus 1′, so that the modular multilevel converter 20 absorbs reactive power from or outputs reactive power to the alternating-current power supply AC1 and the modular multilevel converter 20′ absorbs reactive power from or outputs reactive power to the alternating-current power supply AC1′, and the voltage source type direct-current ice melting apparatus 1 performs reactive power compensation on the alternating-current power supply AC1 and the voltage source type direct-current ice melting apparatus 1′ performs reactive power compensation on the alternating-current power supply AC1′.

It should be understood that the flexible interconnection system 6, operating in the flexible interconnection mode, is not connected to the to-be-melted line 2. For example, the flexible interconnection system 6 is disconnected with the to-be-melted line 2.

In an embodiment, the flexible interconnection system 6 may perform direct-current ice melting. When the flexible interconnection system 6 enters into the direct-current ice melting mode, common terminals 201 and 202, of the direct current output terminal 22 of the modular multilevel inverters 20 and the direct current output terminal 22′ of the modular multilevel inverters 20′ connected in parallel in the flexible interconnection system 6, are respectively connected to two ends of the to-be-melted line 2. The starting unit 10 controls an alternating current to flow to the modular multilevel converter 20, and the starting unit 10′ controls an alternating current to flow to the modular multilevel converter 20′. The measurement control unit 30 controls the operation state of the modular multilevel converter 20, and the modular multilevel converter 20 outputs a direct current through the direct-current output terminal 22; and the measurement control unit 30′ controls the operation state of the modular multilevel converter 20′, and the modular multilevel converter 20′ outputs a direct current through the direct-current output terminal 22′. The measurement control unit 30 controls the operation state of the modular multilevel converter 20, so that the direct current outputted through the direct-current output terminals 22 of the modular multilevel converter 20 may be adjusted to several hundred amperes or several thousand amperes. The measurement control unit 30′ controls the operation state of the modular multilevel converter 20′, so that the direct current outputted through the direct-current output terminals 22′ of the modular multilevel converter 20′ may be adjusted to several hundred amperes or several thousand amperes. After the direct current flows through the to-be-melted line 2, the to-be-melted line 2 generates enough heat to melt the ice covering the surface of the to-be-melted line 2.

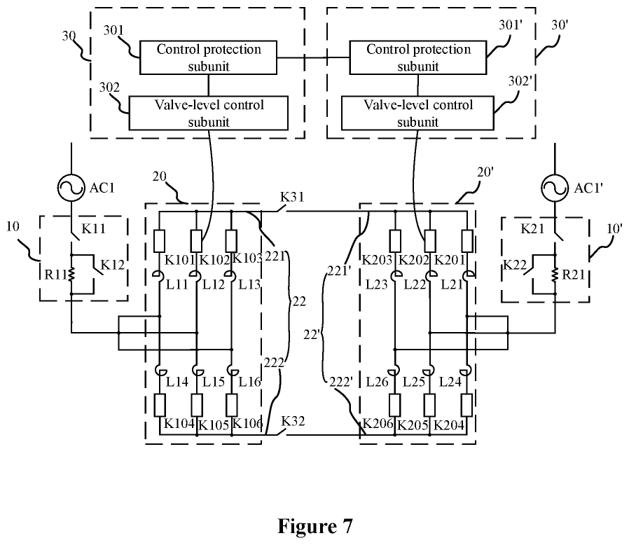

Based on the circuit diagram of the voltage source type direct-current ice melting apparatus 1 described in the above embodiments, a circuit diagram of a flexible interconnection system 6 is provided in an embodiment of the present disclosure, as shown in FIG. 7.

The measurement control unit 30 in the voltage source type direct-current ice melting apparatus 1 in the flexible interconnection system 6 may include: a control protection subunit 301, a valve-level control subunit 302, and a measurement subunit. The measurement control unit 30′ in the voltage source type direct-current ice melting apparatus 1′ in the flexible interconnection system 6 may include: a control protection subunit 301′, a valve-level control subunit 302′, and a measurement subunit. The connection between the measurement control unit 30 in the voltage source type direct-current ice melting apparatus 1 and the measurement control unit 30′ in the voltage source type direct-current ice melting apparatus 1′ may be performed by connecting the control protection subunit 301 and the control protection subunit 301′. In addition, the control protection subunit 301 in the voltage source type direct-current ice melting apparatus 1 and the control protection subunit 301′ in the voltage source type direct-current ice melting apparatus 1′ may be a same unit. FIG. 7 only shows an example in which the control protection subunit 301 of the measurement control unit 30 in the voltage source type direct-current ice melting apparatus 1 is connected to the control protection subunit 301′ of the measurement control unit 30′ in the voltage source type direct-current ice melting apparatus 1′.

In an embodiment of the present disclosure, referring to FIG. 7, the flexible interconnection system 6 may further include a third switch (switch K31) and a fourth switch (switch K32). In the flexible interconnection system 6, direct-current output terminals 22 of the modular multilevel inverter 20 is connected to direct current output terminals 22′ of the modular multilevel inverters 20′ respectively through the switch K31 and the switch K32, thereby connecting the voltage source type direct-current ice melting apparatus 1 and the voltage source type direct-current ice melting apparatus 1′ in parallel at the direct-current side. Specifically, a terminal of the switch K31 is connected to a first output terminal 221 of the modular multilevel converter 20 in the voltage source type direct-current ice melting apparatus 1, another terminal of the switch K31 is connected to a first output terminal 221′ of the modular multilevel converter 20′ in the voltage source type direct-current ice melting apparatus 1′, a terminal of the switch K32 is connected to a second output terminal 222 of the modular multilevel converter 20 in the voltage source type direct-current ice melting apparatus 1, and another terminal of the switch K32 is connected to a second output terminal 222′ of the modular multilevel converter 20′ in the voltage source type direct-current ice melting apparatus 1′, thereby connecting the voltage source type direct-current ice melting apparatus 1 and the voltage source type direct-current ice melting apparatus 1′ in parallel at the direct-current side.

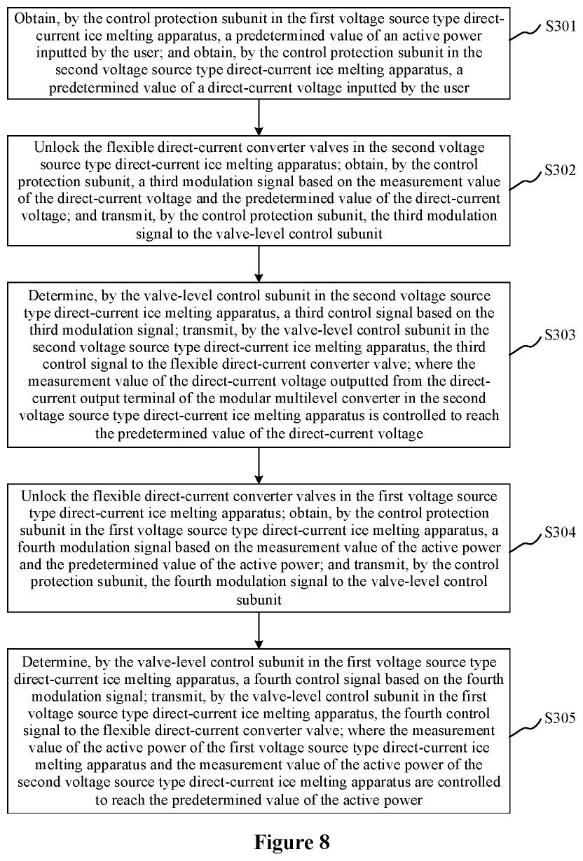

Based on the flexible interconnection system 6 according to the embodiments of the present disclosure, a control method for the flexible interconnection system 6 operating in the flexible interconnection mode is further provided in the present disclosure. Based on the circuit diagram shown in FIG. 7, FIG. 8 shows a logical block diagram of a control method for a flexible interconnection system operating in a flexible interconnection mode according to an embodiment of the present disclosure. Referring to FIG. 8, the voltage source type direct-current ice melting apparatus 1 is referred to as a first voltage source type direct-current ice melting apparatus, and the voltage source type direct-current ice melting apparatus 1′ is referred to as a second voltage source type direct-current ice melting apparatus. The control method may include the following steps S301 to S305.

In step S301, a control protection subunit in the first voltage source type direct-current ice melting apparatus obtains a predetermined value of an active power inputted by the user, and a control protection subunit in the second voltage source type direct-current ice melting apparatus obtains a predetermined value of a direct-current voltage inputted by the user.

Specifically, according to requirements, the user inputs a predetermined value of an active power to the control protection subunit 301 of the measurement control unit 30 and inputs a predetermined value of a direct-current voltage to the control protection subunit 301′ of the measurement control unit 30′. It should be understood that the control protection subunits 301 may obtain the predetermined value of the active power inputted by the user through a control interface, the control protection subunits 301′ may obtain the predetermined value of the direct-current voltage inputted by the user through the control interface. The predetermined value of the active power is configured by the user based on a rated operation condition of the alternating-current power supply, and the predetermined value of the direct-current voltage is configured by the user based on a stable operation state of the system.

In step S302, flexible direct-current converter valves in the second voltage source type direct-current ice melting apparatus are unlocked, the control protection subunit obtains a third modulation signal based on the measurement value of the direct-current voltage and the predetermined value of the direct-current voltage, and the control protection subunit transmits the third modulation signal to the valve-level control subunit.

Specifically, the step of unlocking the flexible direct-current converter valves (K201, K202, K203, K204, K205 and K206) in the second voltage source type direct-current ice melting apparatus is similar to the step of unlocking the flexible direct-current converter valves in step S102 of the control method for the voltage source type direct-current ice melting apparatus 1 operating in the direct-current ice melting mode shown in FIG. 3.

The control protection subunit 301′ obtains the measurement value of the direct-current voltage through a direct-current voltage measurement subunit arranged in the voltage source type direct-current ice melting apparatus 1′, obtains the third modulation signal based on the measurement value of the direct-current voltage and the predetermined value of the direct-current voltage inputted by the user, and transmits the third modulation signal to the valve-level control subunit 302′. It should be noted that for the sake of simplicity in the figures, the measurement subunits are not shown in the figures. The specific positions are determined based on that measurement of real-time measurement values of parameters can be performed.

In step S303, the valve-level control subunit in the second voltage source type direct-current ice melting apparatus determines a third control signal based on the third modulation signal, and transmits the third control signal to the flexible direct-current converter valve. Thus, the measurement value of the direct-current voltage outputted from the direct-current output terminal of the modular multilevel converter in the second voltage source type direct-current ice melting apparatus reaches the predetermined value of the direct-current voltage.

Specifically, the valve-level control subunit 302′ determines the third control signal based on the third modulation signal and transmits the third control signal to the flexible direct-current converter valves (K201, K202, K203, K204, K205 and K206) in the modular multilevel converter 30′, so that the measurement value of the direct-current voltage at the direct-current output terminal 22′ of the modular multilevel converter 30′ may reach the predetermined value of the direct-current voltage inputted by the user, ensuring that the flexible interconnection system 6 remains in a stable state and providing support for the valve-level control subunit 302 controlling the flexible direct-current converter valves (K101, K102, K103, K104, K105 and K106) to absorb or transmit an active power in subsequent.

In step S304, the flexible direct-current converter valves in the first voltage source type direct-current ice melting apparatus are unlocked, the control protection subunit in the first voltage source type direct-current ice melting apparatus obtains a fourth modulation signal based on the measurement value of the active power and the predetermined value of the active power, and transmits the fourth modulation signal to the valve-level control subunit.

Specifically, when the measurement value of the direct-current voltage reaches the predetermined value of the direct-current voltage, the measurement control unit 301′ transmits a second signal to the measurement control unit 301. Only after the capacitor voltage of the flexible direct-current converter valves (K101, K102, K103, K104, K105 and K106) reaches a predetermined threshold and the measurement control unit 301 receives the second signal, the valve-level control subunit 302 controls the flexible direct-current converter valves (K101, K102, K103, K104, K105 and K106) to be unlocked to start to operate. It should be noted that in addition to using the second signal as a condition for unlocking, the step of unlocking the flexible direct-current converter valves (K101, K102, K103, K104, K105 and K106) in the first voltage source type direct-current ice melting apparatus is similar to the step of unlocking the flexible direct-current converter valves in step S102 of the control method for the voltage source type direct-current ice melting apparatus 1 operating in the direct-current ice melting mode shown in FIG. 3.

The flexible direct-current converter valves (K101, K102, K103, K104, K105 and K106) start to operate. The voltage source type direct-current ice melting apparatus 1 in the flexible interconnection system 6 is arranged with a measurement subunit for measuring an active power at the alternating-current power supply side of the voltage source type direct-current ice melting apparatus 1, and the voltage source type direct-current ice melting apparatus 1′ in the flexible interconnection system 6 is arranged with a measurement subunit for measuring an active power at the alternating-current power supply side of the voltage source type direct-current ice melting apparatus 1′. The measurement subunit arranged in the voltage source type direct-current ice melting apparatus 1 may obtain in real time the measurement value of the active power at the alternating-current power supply side of the voltage source type direct-current ice melting apparatus 1, and transmits the measurement value of the active power to the control protection subunit in the voltage source type direct-current ice melting apparatus 1. The measurement subunit arranged in the voltage source type direct-current ice melting apparatus 1′ may obtain in real time the measurement value of the active power at the alternating-current power supply side of the voltage source type direct-current ice melting apparatus 1′, and transmits the measurement value of the active power to the control protection subunit in the voltage source type direct-current ice melting apparatus 1′.

The control protection subunit 301′ receives a measurement value of a second active power transmitted in real time by the measurement subunit arranged in the voltage source type direct-current ice melting apparatus 1, and then transmits the measurement value of the second active power to the control protection subunit 301 in real time. The control protection subunit 301 obtain a fourth modulation signal based on the obtained measurement value of the first active power of the voltage source type direct-current ice melting apparatus 1′, the measurement value of the second active power received from the measurement control unit 301′ and the predetermined value of the active power previously inputted by the user, and transmits the fourth modulation signal to the valve-level control subunit 302.

In addition, in the step of unlocking the flexible direct-current converter valves (K101, K102, K103, K104, K105 and K106) in the first voltage source type direct-current ice melting apparatus, the measurement control unit 301′ may not transmit the second signal to the measurement control unit 301, and the measurement control unit 301′, after obtaining the predetermined value of the direct-current voltage inputted by the user, may directly transmit the predetermined value of the direct-current voltage to the measurement control unit 301. Since the direct-current output terminal 22 of the modular multilevel converter 20 in the flexible interconnection system 6 and the direct-current output terminal 22′ of the modular multilevel converter 20′ in the flexible interconnection system 6 are connected in parallel, the direct-current voltage of the direct-current output terminal 22 of the modular multilevel converter 20 is same as the direct-current voltage of the direct-current output terminal 22′ of the modular multilevel converter 20′, and thus the control protection subunit 301′ may transmit the predetermined value of the direct-current voltage inputted by the user to the control protection subunit 301. The direct-current voltage measurement subunit arranged in the first voltage source type direct-current ice melting apparatus measures the direct-current voltage of the direct-current output terminal 22 of the modular multilevel converter 20 in real time, and transmits a measurement value of the direct-current voltage to the control protection subunit 301. The control protection subunit 301 performs determination based on the obtained predetermined value of the direct-current voltage and the measurement value of the direct-current voltage. When the control protection subunit 301 determines that both the measurement value of the direct-current voltage of the direct-current output terminal 22 of the flexible interconnection system 6 and the measurement value of the direct-current voltage of the direct-current output terminal 22′ of the flexible interconnection system 6 reach the predetermined value of the direct-current voltage and the capacitor voltage of the flexible direct-current converter valves (K101, K102, K103, K104, K105 and K106) reach the predetermined threshold, the valve-level control subunit 302 controls the flexible direct-current converter valves (K101, K102, K103, K104, K105 and K106) to be unlocked to start to operate.

Further, in the step of unlocking the flexible direct-current converter valves (K101, K102, K103, K104, K105 and K106) in the first voltage source type direct-current ice melting apparatus 1, it may be unnecessary for the control protection subunit 301 to receive a signal or a predetermined value from the control protection subunit 301′, the control protection subunit 301 may obtain the predetermined value of the direct-current voltage inputted by the user and obtain the predetermined value of the active power. The predetermined value of the direct-current voltage inputted by the user obtained by the control protection subunit 301 is the same as the predetermined value of the direct-current voltage inputted by the user obtained by the control protection subunit 301′. The direct-current voltage measurement subunit arranged in the first voltage source type direct-current ice melting apparatus 1 measures the direct-current voltage of the direct-current output terminal 22 of the modular multilevel converter 20 in real time, and transmits a measurement value to the control protection subunit 301. When the measurement value of the direct-current voltage of the direct-current output terminal 22 of the modular multilevel converter 20 reaches the predetermined value of the direct-current voltage, the control protection subunit 301 may perform internal detection without receiving a signal or a predetermined value from the control protection subunit 301′. When the measurement value of the direct-current voltage of the direct-current output terminal 22 of the modular multilevel converter 20 reaches the predetermined value of the direct-current voltage and the capacitor voltage of the flexible direct current converter valves (K101, K102, K103, K104, K105 and K106) reaches the predetermined threshold, the valve-level control subunit 302 controls the flexible direct current converter valves (K101, K102, K103, K104, K105 and K106) to be unlocked to start to operate.

In step S305, the valve-level control subunit in the first voltage source type direct-current ice melting apparatus determines a fourth control signal based on the fourth modulation signal, and transmits the fourth control signal to the flexible direct current converter valve. The measurement value of the active power of the first voltage source type direct-current ice melting apparatus and the measurement value of the active power of the second voltage source type direct-current ice melting apparatus reach the predetermined value of the active power.

Specifically, the valve-level control subunit 302 determines a fourth control signal based on the fourth modulation signal, and transmits the fourth control signal to the flexible direct current converter valves (K101, K102, K103, K104, K105 and K106) in the modular multilevel converter 20 to control the operation states of the flexible direct current converter valves (K101, K102, K103, K104, K105 and K106) to absorb an active power from or transmit an active power to the second voltage source type direct-current ice melting apparatus 1′, so that the measurement value of the active power of the first voltage source type direct-current ice melting apparatus 1 and the measurement value of the active power of the second voltage source type direct-current ice melting apparatus 1′ reach the predetermined value of the active power.

It should be understood that the control method for the flexible interconnection system 6 operating in the flexible interconnection mode is performed based on the connection between the control protection subunit 301 in the voltage source type direct-current ice melting apparatus 1 and the control protection subunit 301′ in the voltage source type direct-current ice melting apparatus 1′ rather than using a same control protection subunit to control the voltage source type direct-current ice melting apparatus 1 and the voltage source type direct-current ice melting apparatus 11′. In a case that the voltage source type direct-current ice melting apparatus 1 and the voltage source type direct-current ice melting apparatus 1′ share a same control protection subunit, it may be considered that the control protection subunit 301 and the control protection subunit 301′ in the above steps are integrated in a same control protection subunit to perform the control method for the flexible interconnection system 6 operating in the flexible interconnection mode.

The flexible interconnection system 6 according to the embodiments of the present disclosure may operate in the flexible interconnection mode, and may further perform reactive power compensation for the reactive power of the alternating-current power supply AC1 in the voltage source type direct-current ice melting apparatus 1 and for the reactive power of the alternating-current power supply AC1′ in the voltage source type direct-current ice melting apparatus 1′ by configuring a predetermined value of a reactive power in the voltage source type direct-current ice melting apparatus 1 and the voltage source type direct-current ice melting apparatus 1′. The reactive compensation and the flexible interconnection may be performed simultaneously.

Specifically, after the user inputs a predetermined value of an active power and a predetermined value of a first reactive power to the first voltage source type direct-current ice melting apparatus 1 and inputs a predetermined value of a direct-current voltage and a predetermined value of a second reactive power to the second voltage source type direct-current ice melting apparatus 1′, the flexible interconnection system 6 may perform the control method for the flexible interconnection system 6 operating in the flexible interconnection mode as shown in FIG. 8 based on the predetermined value of the active power and the predetermined value of the direct-current voltage, thereby performing flexible interconnection between the alternating current power supply AC1 corresponding to the voltage source type direct-current ice melting apparatus 1 and the alternating current power supply AC1′ corresponding to the voltage source type direct-current ice melting apparatus 1′. In addition, based on the predetermined value of the first reactive power and the predetermined value of the second reactive power, the voltage source type direct-current ice melting apparatus 1 and the voltage source type direct-current ice melting apparatus 1′ in the flexible interconnection system 6 may perform the control method for the voltage source type direct-current ice melting apparatus 1 operating in the reactive compensation mode as shown in FIG. 5, thereby performing reactive power compensation for the alternating current power supply AC1 corresponding to the voltage source type direct-current ice melting apparatus 1 and performing reactive power compensation for the alternating current power supply AC1′ corresponding to the voltage source type direct-current ice melting apparatus 1′.

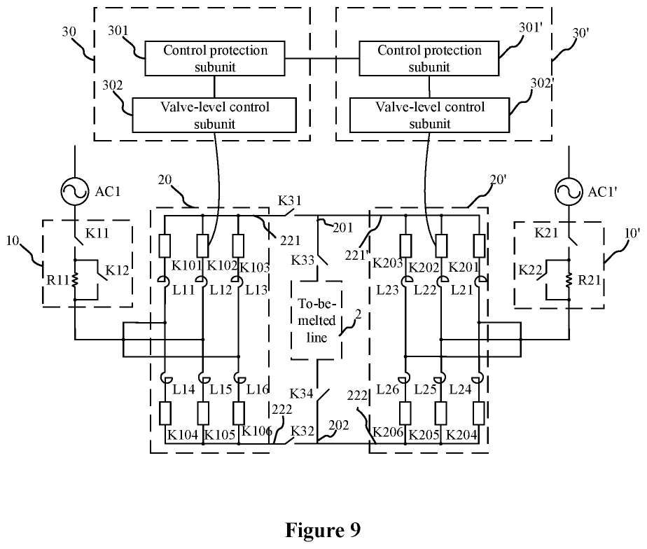

The flexible interconnection system 6 according to the embodiments of the present disclosure may further perform direct-current ice melting. As shown in FIG. 9, in the flexible interconnection system 9 performing the direct-current ice melting, it is required to connect common terminals 201 and 202, of the direct-current output terminal 22 (including 221 and 222) of modular multilevel inverter 20 and the direct-current output terminal 22′ (including 221′ and 222′) of modular multilevel inverter 20′ connected in parallel in the flexible interconnection system 9, to two terminals of the to-be-melted line 2, respectively.

In an embodiment, as shown in FIG. 9, the flexible direct current system 6 may further include a fifth switch (switch K33) and a sixth switch (switch K34). The first common terminal 201, of the first output terminal 221 of the modular multilevel inverter 20 in the voltage source type direct-current ice melting apparatus 1 and the first output terminal 221′ of the modular multilevel inverter 20′ in the voltage source type direct-current ice melting apparatus 1′ connected in parallel in the flexible interconnection system 6, is connected to the to-be-melted line 2 through the switch K33. The second common terminal 201, of the second output terminal 222 of the modular multilevel inverter 20 and the second output terminal 222′ of the modular multilevel inverter 20′ connected in parallel, is connected to the to-be-melted line 2 through the switch K34.

It should be understood that in a case that the flexible interconnection system 6 performs direct-current ice melting, the flexible interconnection system 6 is connected to the to-be-melted line 6. The voltage source type direct-current ice melting apparatus 1 and the voltage source type direct-current ice melting apparatus 1′ in the flexible interconnection system 6 perform the control method for the voltage source type direct-current ice melting apparatus 1 operating in the direct-current ice melting mode as shown in FIG. 3. Both the direct-current output terminal 22 of the modular multilevel inverter 20 in the voltage source type direct-current ice melting apparatus 1 and the direct-current output terminal 22′ of the modular multilevel inverter 20′ in the voltage source type direct-current ice melting apparatus 1′ output direct current of several hundred amperes or several thousand amperes. After the direct current flows through the to-be-melted line 2, the to-be-melted line 2 generates enough heat to melt the ice covering on the surface of the to-be-melted line 2.

Finally, it should be further noted that the relationship terms herein such as “first”, “second” and the like are only used to distinguish one entity or operation from another, rather than necessitate or imply that any such actual relationship or order exists between these entities or operations. Moreover, the terms “comprise”, “include”, or any other variants thereof are intended to encompass a non-exclusive inclusion, such that the process, method, article, or device including a series of elements includes not only those elements but also those elements that are not explicitly listed, or the elements that are inherent to such process, method, article, or device. Unless explicitly limited, the statement “including a . . . ” does not exclude the case that other similar elements may exist in the process, the method, the article or the device other than enumerated elements.

The embodiments in this specification are described in a progressive way, each of which emphasizes the differences from others. The embodiments may be combined as needed, and the same or similar parts among the embodiments may be referred to each other.

Those skilled in the art may implement or practice the present disclosure based on the above descriptions of the disclosed embodiments. Numerous modifications to the embodiments will be apparent to those skilled in the art, and the general principle herein can be implemented in other embodiments without deviation from the spirit or scope of the embodiments of the present application. Therefore, the present application shall not be limited to the embodiments described herein but have the widest scope that complies with the principle and novelty disclosed in this specification.

1. A voltage source type direct-current ice melting apparatus, comprising:
a starting unit;
a modular multilevel converter; and
a measurement control unit; wherein
a terminal of the starting unit is connected to an alternating-current power supply terminal, another terminal of the starting unit is connected to an alternating-current input terminal of the modular multilevel converter, the starting unit is configured to connect the modular multilevel converter to an alternating-current power supply via the alternating-current power supply terminal, and a direct-current output terminal of the modular multilevel converter is connected to a to-be-melted line in a case that the voltage source type direct-current ice melting apparatus operates in a direct-current ice melting mode; and
the measurement control unit is connected to the modular multilevel converter, and the measurement control unit is configured to obtain a measurement value of an electrical parameter of the direct-current output terminal of the modular multilevel converter, determine a control signal based on the measurement value of the electrical parameter and a predetermined value of the electrical parameter, and control an operation state of the modular multilevel converter based on the control signal.

2. The voltage source type direct-current ice melting apparatus according to claim 1, wherein
the starting unit comprises an alternating-current breaker, a charging resistor, and a bypass switch; and
the bypass switch and the charging resistor are connected in parallel, a first common terminal of the bypass switch and the charging resistor connected in parallel is connected to the alternating-current power supply terminal through the alternating-current breaker, and a second common terminal of the bypass switch and the charging resistor connected in parallel is connected to the alternating-current input terminal of the modular multilevel converter.

3. The voltage source type direct-current ice melting apparatus according to claim 1, wherein
the modular multilevel converter comprises a first phase, a second phase and a third phase which have a same structure;
each of the first phase, the second phase and the third phase comprises an upper bridge arm and a lower bridge arm, and each of upper bridge arms and lower bridge arms comprises a bridge arm reactor and a flexible direct-current converter valve connected in series;
in each of the first phase, the second phase and the third phase, the bridge arm reactor in the upper bridge arm and the bridge arm reactor in the lower bridge arm are connected in series in a same direction;
in each of the first phase, the second phase and the third phase, a connection point of the upper bridge arm and a connection point of the lower bridge arm are connected to the starting unit; and
in each of the first phase, the second phase and the third phase in the modular multilevel converter, the flexible direct-current converter valve in the upper bridge arm and the flexible direct-current converter valve in the lower bridge arm are connected to the measurement control unit.

4. The voltage source type direct-current ice melting apparatus according to claim 1, wherein
the measurement control unit comprises: a control protection subunit, a valve-level control subunit, and a measurement subunit;
the measurement subunit is configured to measure the electrical parameter of the direct-current output terminal of the modular multilevel converter or an electrical parameter of the alternating-current power supply terminal to obtain a measurement value of the electrical parameter;
the valve-level control subunit is connected to the modular multilevel converter, and the valve-level control subunit is configured to control the operation state of the modular multilevel converter; and
the control protection subunit is connected to the valve-level control subunit and the measurement subunit, and the control protection subunit is configured to receive the measurement value of the electrical parameter from the measurement subunit, and transmit the control signal to the valve-level control subunit to control the operation state of the modular multilevel converter.

5. The voltage source type direct-current ice melting apparatus according to claim 1, further comprising:
a first switch; and
a second switch; wherein
the direct-current output terminal of the modular multilevel converter is connected to the to-be-melted line via the first switch and the second switch.

6. The voltage source type direct-current ice melting apparatus according to claim 1, wherein
the measurement control unit is connected to the starting unit; and
the measurement control unit is configured to transmit a switch signal to the starting unit, and the starting unit is configured to adjust a current value of an alternating current to flow to the voltage source type direct-current ice melting apparatus based on the switch signal.

7. A flexible interconnection system, comprising:
a first voltage source type direct-current ice melting apparatus; and
a second voltage source type direct-current ice melting apparatus; wherein
each of the first voltage source type direct-current ice melting apparatus and the second voltage source type direct-current ice melting apparatus comprises the voltage source type direct-current ice melting apparatus according to claim 1;
the measurement control unit in the first voltage source type direct-current ice melting apparatus is connected to the measurement control unit in the second voltage source type direct-current ice melting apparatus; and
the direct-current output terminal of the modular multilevel converter in the first voltage source type direct-current ice melting apparatus is connected to the direct-current output terminal of the modular multilevel converter in the second voltage source type direct-current ice melting apparatus, wherein the first voltage source type direct-current ice melting apparatus and the second voltage source type direct-current ice melting apparatus are connected in parallel at the direct-current output terminals.

8. The flexible interconnection system according to claim 7, further comprising:
a third switch; and
a fourth switch; wherein
the direct-current output terminal of the modular multilevel converter in the first voltage source type direct-current ice melting apparatus is connected to the direct-current output terminal of the modular multilevel converter in the second voltage source type direct-current ice melting apparatus via the third switch and the fourth switch.

9. The flexible interconnection system according to claim 7, wherein
in the direct-current ice melting mode, a first common terminal, of the direct-current output terminal of the modular multilevel inverter in the first voltage source type direct-current ice melting apparatus and the direct-current output terminal of the modular multilevel inverter in the second voltage source type direct-current ice melting apparatus connected in parallel, is connected to a terminal of the to-be-melted line, and a second common terminal, of the direct-current output terminal of the modular multilevel inverter in the first voltage source type direct-current ice melting apparatus and the direct-current output terminal of the modular multilevel inverter in the second voltage source type direct-current ice melting apparatus connected in parallel, is connected to another terminal of the to-be-melted line.

10. The flexible interconnection system according to claim 9, further comprising:
a fifth switch; and
a sixth switch; wherein
a first common terminal, of the modular multilevel inverter in the first voltage source type direct-current ice melting apparatus and the modular multilevel inverter in the second voltage source type direct-current ice melting apparatus connected in parallel, is connected to the terminal of the to-be-melted line, and a second output terminal, of the modular multilevel inverter in the first voltage source type direct-current ice melting apparatus and the modular multilevel inverter in the second voltage source type direct-current ice melting apparatus connected in parallel, is connected to the another terminal of the to-be-melted line.

11. A control method for a voltage source type direct-current ice melting apparatus, performed by the voltage source type direct-current ice melting apparatus according to claim 1, wherein
in a case that the voltage source type direct-current ice melting apparatus operates in the direct-current ice melting mode, the direct-current output terminal of the modular multilevel converter is connected to the to-be-melted line, and the control method comprises:
controlling, by the starting unit, an alternating current to flow to the modular multilevel converter;
converting, by the modular multilevel converter 20, the alternating current to a direct current, and outputting the direct current via the direct-current output terminal of the modular multilevel converter; and
obtaining, by the measurement control unit, a measurement value and a predetermined value of the direct current outputted via the direct-current output terminal, and controlling the operation state of the modular multilevel converter based on the measurement value and the predetermined value of the direct current to control a current value of a direct current outputted from the direct-current output terminal to the to-be-melted line.

12. The control method for a voltage source type direct-current ice melting apparatus according to claim 11, wherein in the case that the voltage source type direct-current ice melting apparatus operates in the direct-current ice melting mode, the control method comprises:
obtaining, by the measurement control unit, a value of an inputted direct-current ice melting current;
obtaining, by the measurement control unit, a capacitor voltage of the modular multilevel converter, wherein the capacitor voltage is generated after the alternating current is inputted to the modular multilevel converter via the starting unit;
transmitting, by the measurement control unit on detecting that the capacitor voltage reaches a predetermined first threshold, a first signal to the modular multilevel converter to instruct the modular multilevel converter to unlock based on the first signal;
obtaining, by the measurement control unit, the measurement value of the direct current outputted via the direct-current output terminal of the modular multilevel converter;
determining, by the measurement control unit, a first control signal based on the measurement value of the direct current and the value of the direct-current ice melting current, wherein the first control signal is used for controlling the operation state of the modular multilevel converter; and
transmitting, by the measurement control unit, the first control signal to the modular multilevel converter, wherein the measurement value of the direct current outputted from the direct-current output terminal of the modular multilevel converter reaches the value of the direct-current ice melting current.

13. A control method for a voltage source type direct-current ice melting apparatus, performed by the voltage source type direct-current ice melting apparatus according to claim 1, wherein
in a case that the voltage source type direct-current ice melting apparatus operates in a reactive power compensation mode, the direct-current output terminal of the modular multilevel converter is not connected to the to-be-melted line, and the control method comprises:
controlling, by the starting unit, an alternating current to flow to the modular multilevel converter; and
controlling, by the measurement control unit, the operation state of the modular multilevel converter to control the modular multilevel converter to absorb a reactive power from the alternating-current power supply terminal or to output a reactive power to the alternating-current power supply terminal.

14. The control method for a voltage source type direct-current ice melting apparatus according to claim 13, wherein the controlling, by the measurement control unit, the operation state of the modular multilevel converter to control the modular multilevel converter to absorb a reactive from the alternating-current power supply terminal or to output a reactive power to the alternating-current power supply terminal comprises:
controlling, by the measurement control unit, the modular multilevel converter to absorb the reactive power from the alternating-current power supply terminal in a case that the measurement control unit measures that the reactive power at the alternating-current power supply terminal is greater than a first predetermined value; and
controlling, by the measurement control unit, the modular multilevel converter to output the reactive power to the alternating-current power supply terminal in a case that the measurement control unit measures that the reactive power at the alternating-current power supply terminal is less than a second predetermined value.

15. The control method for a voltage source type direct-current ice melting apparatus according to claim 13, comprising:
obtaining, by the measurement control unit, an inputted predetermined value of a direct-current voltage and an inputted predetermined value of an alternating-current parameter, wherein the alternating-current parameter is an alternating-current parameter of the alternating-current power supply terminal after the modular multilevel converter absorbs the reactive from the alternating-current power supply terminal or outputs the reactive power to the alternating-current power supply terminal;
obtaining, by the measurement control unit, a capacitor voltage of the modular multilevel converter, wherein the capacitor voltage is generated after the alternating current is inputted to the modular multilevel converter via the starting unit;
transmitting, by the measurement control unit on detecting that the capacitor voltage reaches a predetermined first threshold, a first signal to the modular multilevel converter to instruct the modular multilevel converter to unlock based on the first signal;
obtaining, by the measurement control unit, the measurement value of the direct current outputted via the direct-current output terminal of the modular multilevel converter and a measurement value of the alternating-current parameter of the alternating-current power supply terminal;
determining, by the measurement control unit, a second control signal based on the measurement value of the direct-current voltage, the predetermined value of the direct-current voltage, the measurement value of the alternating-current parameter, and the predetermined value of the alternating-current parameter, wherein the second control signal is used for controlling the operation state of the modular multilevel converter; and
transmitting, by the measurement control unit, the second control signal to the modular multilevel converter, wherein the measurement value of the direct-current voltage of the direct-current output terminal of the modular multilevel converter reaches the predetermined value of the direct-current voltage and the measurement value of the alternating-current parameter of the alternating-current power supply terminal reaches the predetermined value of the alternating-current parameter.

16. A control method for a flexible interconnection system, performed by the flexible interconnection system according to claim 7, wherein
in a case that the flexible interconnection system operates in a flexible interconnection mode, the direct-current output terminal of the modular multilevel converter in the first voltage source type direct-current ice melting apparatus and the direct-current output terminal of the modular multilevel converter in the second voltage source type direct-current ice melting apparatus are not connected to the to-be-melted line, and the control method comprises:
controlling, by the starting unit in the first voltage source type direct-current ice melting apparatus, an alternating current to flow to the modular multilevel converter in the first voltage source type direct-current ice melting apparatus, and controlling, by the starting unit in the second voltage source type direct-current ice melting apparatus, an alternating current to flow to the modular multilevel converter in the second voltage source type direct-current ice melting apparatus;
converting, by the modular multilevel inverter in the first voltage source type direct-current ice melting apparatus, the alternating current to a direct current, and outputting, by the modular multilevel inverter in the first voltage source type direct-current ice melting apparatus, the direct current; and converting, by the modular multilevel inverter in the second voltage source type direct-current ice melting apparatus, the alternating current to a direct current, and outputting, by the modular multilevel inverter in the second voltage source type direct-current ice melting apparatus, the direct current; and
controlling, by the measurement control unit in the first voltage source type direct-current ice melting apparatus, the operation state of the modular multilevel converter in the first voltage source type direct-current ice melting apparatus, and controlling, by the measurement control unit in the second voltage source type direct-current ice melting apparatus, the operation state of the modular multilevel converter in the second voltage source type direct-current ice melting apparatus, wherein an active power is transferred between the alternating-current power supply terminal connected to the first voltage source type direct-current ice melting apparatus and the alternating-current power supply terminal connected to the second voltage source type direct-current ice melting apparatus.

17. The control method for a flexible interconnection system according to claim 16, wherein the active power is transferred between the alternating-current power source terminal connected to the first voltage source type direct-current ice melting apparatus and the alternating-current power supply terminal connected to the second voltage source type direct-current ice melting apparatus by:
absorbing, by the modular multilevel converter in the first voltage source type direct-current ice melting apparatus, an active power of the alternating-current power supply terminal connected to the second voltage source type direct-current ice melting apparatus in a case that an active power of the alternating-current power supply terminal connected to the first voltage source type direct-current ice melting apparatus is less than a third predetermined value and the active power of the alternating-current power supply terminal connected to the second voltage source type direct-current ice melting apparatus is greater than a fourth predetermined value; and
outputting, by the modular multilevel converter in the first voltage source type direct-current ice melting apparatus, an active power to the alternating-current power supply terminal connected to the second voltage source type direct-current ice melting apparatus in a case that an active power of the alternating-current power supply terminal connected to the first voltage source type direct-current ice melting apparatus is great than a fourth predetermined value and an active power of the alternating-current power supply terminal connected to the second voltage source type direct-current ice melting apparatus is less than a third predetermined value.

18. The control method for a flexible interconnection system according to claim 17, comprising:
obtaining, by the measurement control unit in the first voltage source type direct-current ice melting apparatus, an inputted predetermined active power value, and obtaining, by the measurement control unit in the second voltage source type direct-current ice melting apparatus, an inputted predetermined direct-current voltage value;
obtaining, by the measurement control unit in the first voltage source type direct-current ice melting apparatus, a capacitor voltage of the modular multilevel converter in the first voltage source type direct-current ice melting apparatus, and obtaining, by the measurement control unit in the second voltage source type direct-current ice melting apparatus, a capacitor voltage of the modular multilevel converter in the second voltage source type direct-current ice melting apparatus, wherein the capacitor voltage, obtained by the measurement control unit in the first voltage source type direct-current ice melting apparatus, is generated after the alternating current is inputted to the modular multilevel converter in the first voltage source type direct-current ice melting apparatus via the starting unit in the first voltage source type direct-current ice melting apparatus, and the capacitor voltage, obtained by the measurement control unit in the second voltage source type direct-current ice melting apparatus, is generated after the alternating current is inputted to the modular multilevel converter in the second voltage source type direct-current ice melting apparatus via the starting unit in the second voltage source type direct-current ice melting apparatus;
transmitting, by the measurement control unit in the second voltage source type direct-current ice melting apparatus after detecting that the capacitor voltage of the modular multilevel converter in the second voltage source type direct-current ice melting apparatus reaches a predetermined first threshold, a first signal to the modular multilevel converter in the second voltage source type direct-current ice melting apparatus to instruct the modular multilevel converter in the second voltage source type direct-current ice melting apparatus to unlock based on the first signal;
obtaining, by the measurement control unit in the second voltage source type direct-current ice melting apparatus, a measurement value of the direct-current voltage of the direct-current output terminal of the modular multilevel converter in the second voltage source type direct-current ice melting apparatus;
determining, by the measurement control unit in the second voltage source type direct-current ice melting apparatus, a third control signal based on the measurement value of the direct-current voltage and the predetermined value of the direct-current voltage, wherein the third control signal is used for controlling the operation state of the modular multilevel converter in the second voltage source type direct-current ice melting apparatus;
transmitting, by the measurement control unit in the second voltage source type direct-current ice melting apparatus, the third control signal to the modular multilevel converter in the second voltage source type direct-current ice melting apparatus, wherein the measurement value of the direct-current voltage of the direct-current output terminal of the modular multilevel converter in the second voltage source type direct-current ice melting apparatus reaches the predetermined value of the direct-current voltage;
transmitting, by the measurement control unit in the second voltage source type direct-current ice melting apparatus after the measurement value of the direct-current voltage of the direct-current output terminal of the modular multilevel converter in the second voltage source type direct-current ice melting apparatus reaches the predetermined value of the direct-current voltage, a second signal to the measurement control unit in the first voltage source type direct-current ice melting apparatus;
transmitting, by the measurement control unit in the first voltage source type direct-current ice melting apparatus after detecting that the capacitor voltage of the modular multilevel converter in the first voltage source type direct-current ice melting apparatus reaches a predetermined first threshold and the measurement control unit in the first voltage source type direct-current ice melting apparatus receives the second signal, a first signal to the modular multilevel converter in the first voltage source type direct-current ice melting apparatus to instruct the modular multilevel converter in the first voltage source type direct-current ice melting apparatus to unlock based on the first signal;
obtaining, by the measurement control unit in the first voltage source type direct-current ice melting apparatus, a measurement value of a first active power of the alternating-current power supply terminal connected to the first voltage source type direct-current ice melting apparatus;
receiving, by the measurement control unit in the first voltage source type direct-current ice melting apparatus, a measurement value of a second active power of the alternating-current power supply terminal connected to the second voltage source type direct-current ice melting apparatus from the measurement control unit in the second voltage source type direct-current ice melting apparatus;
determining, by the measurement control unit in the first voltage source type direct-current ice melting apparatus, a fourth control signal based on the measurement value of the first active power, the measurement value of the second active power, and the obtained predetermined value of the active power, wherein the fourth control signal is used for controlling the operation state of the modular multilevel converter in the first voltage source type direct-current ice melting apparatus; and
transmitting, by the measurement control unit in the first voltage source type direct-current ice melting apparatus, the fourth control signal to the modular multilevel converter in the first voltage source type direct-current ice melting apparatus, wherein the measurement value of the first active power and the measurement value of the second active power are controlled to reach the predetermined value of the active power.

19. A control method for a flexible interconnection system, performed by the flexible interconnection system according to claim 7, wherein
in a case that the flexible interconnection system operates in a direct-current ice melting mode, the direct-current output terminal of the modular multilevel converter in the first voltage source type direct-current ice melting apparatus and the direct-current output terminal of the modular multilevel converter in the second voltage source type direct-current ice melting apparatus are connected in parallel and then are connected to the to-be-melted line, and the control method comprises:
controlling, by the starting unit in the first voltage source type direct-current ice melting apparatus, an alternating current to flow to the modular multilevel converter in the first voltage source type direct-current ice melting apparatus, and controlling, by the starting unit in the second voltage source type direct-current ice melting apparatus, an alternating current to flow to the modular multilevel converter in the second voltage source type direct-current ice melting apparatus;
converting, by the modular multilevel converter in the first voltage source type direct-current ice melting apparatus, the alternating current to a direct current, and outputting the direct current via the direct-current output terminal of the modular multilevel converter in the first voltage source type direct-current ice melting apparatus; and converting, by the modular multilevel converter in the second voltage source type direct-current ice melting apparatus, the alternating current to a direct current, and outputting the direct current via the direct-current output terminal of the modular multilevel converter in the second voltage source type direct-current ice melting apparatus; and
controlling, by the measurement control unit in the first voltage source type direct-current ice melting apparatus, an operation state of the modular multilevel converter in the first voltage source type direct-current ice melting apparatus to control a direct current outputted from the direct-current output terminal of the modular multilevel converter in the first voltage source type direct-current ice melting apparatus to the to-be-melted line; and controlling, by the measurement control unit in the second voltage source type direct-current ice melting apparatus, an operation state of the modular multilevel converter in the second voltage source type direct-current ice melting apparatus to control a direct current outputted from the direct-current output terminal of the modular multilevel converter in the second voltage source type direct-current ice melting apparatus to the to-be-melted line.

20. (canceled)
